(19) United States
(12) Patent Application Publication
(10) Pub. No.: US 2014/0214623 A1
(43) Pub. Date: Jul. 31, 2014

(54) IN-STORE CUSTOMER SCAN PROCESS INCLUDING PRODUCT AUTOMATED INGREDIENT WARNING

(71) Applicant: WAL-MART STORES, INC., Bentonville, AR (US)

(72) Inventors: Richard Neil Cancro, Portland, OR (US); Douglas James Pedley, Portland, OR (US); Joel Bennett Acker, JR., Brush Prairie, WA (US)

(73) Assignee: Wal-Mart Stores, Inc., Bentonville, AR (US)

(21) Appl. No.: 13/754,666

(22) Filed: Jan. 30, 2013

(51) Int. Cl. G06Q 30/06

(52) U.S. Cl. CPC G06Q 30/0623
USPC 705/26.63

(57) ABSTRACT

A computer-implemented process can be implemented to provide a customer with information about an item to be purchased. The process includes monitoring, within a processor of a portable computerized device, a scan of the item to be purchased, automatically referencing a remote database to reference a list of ingredients in the item to be purchased. The process further includes cross-referencing, within the processor, the list of ingredients to a shopping profile of the customer and Fdisplaying an alert to the customer upon a display of the portable computerized device based upon the cross-referencing.

### BACKGROUND INFORMATION

1. Field of the Disclosure

The present disclosure relates generally to a computer implemented process to allow customers to use a portable computerized device to scan goods in a store and allow them to purchase the item. In particular, examples of the present disclosure are related to detecting ingredients of ingestible goods and their suitability for ingestion by the consumer.

2. Background

Portable computerized devices permit a user to collect and process data from surroundings. A portable computerized device can include a camera device configured to capture an image or a series of images which can collectively be defined as a video feed. Programming upon or accessible by the device can process the image or images to identify useful information. The device can include wireless communication to acquire or send information to a remote server device. A device can additionally or alternatively include a microphone to record audio.

Augmented reality includes software applications that superimpose computer-generated images upon a view of the real world. In one embodiment, augmented reality can be operated upon a smart-phone, a tablet computer, or other similar portable device.

Augmented reality can provide computer generated graphical images superimposed upon a visual scene of an area proximate to the viewer. In combination with image recognition and programming permitting identification of features in a view, graphical images can be projected to identify an object of interest in the view. Graphical images can be configured to interact in an amusing way or otherwise entertain the viewer. Graphical images can provide instruction or augment the view with supplemental information. By superimposing images upon a view of objects in the real world, the experience of the viewer can be enhanced with information, entertainment, or other graphical content.

A portable computerized device can include software applications that capture product barcodes, QR codes, images of packaging details, or other identifying marks, and by matching these marks to those in a centralized database, identify the product so that it can then be later used.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a schematic drawing illustrating an exemplary portable computerized device in communication with an exemplary store product index server, according to some embodiments of the disclosure;

FIG. 2 is an exemplary view of a product being scanned by a portable computerized device illustrating that the product does not contain ingredients that the consumer has identified as unwanted, according to some embodiments of the disclosure;

FIG. 3 is an exemplary view through a portable computerized device of a product and graphics projected upon the device illustrating warnings about the ingredients in the product, according to some embodiments of the disclosure;

FIGS. 4A and 4B schematically illustrate exemplary portable computerized devices utilizing the processes disclosed herein, according to some embodiments of the disclosure;

FIG. 5 is an exemplary computer display showing a customer profile and various options for the customer regarding ingredients in products, according to some embodiments of the disclosure;

FIG. 6 is a schematic illustrating an exemplary store product index server, according to some embodiments of the disclosure;

FIG. 7 is a schematic illustrating an exemplary portable computerized device configured to implement processes disclosed herein, according to some embodiments of the disclosure;

FIG. 8 is a flowchart illustrating an exemplary process to create a list of ingredients that the consumer does not wish to purchase, according to some embodiments of the disclosure; and

FIG. 9 is a flowchart illustrating an exemplary process to purchase items in a shopping cart that have been scanned by the customer, according to some embodiments of the disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or processes have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

An individual wishing to customize their purchasing options by, for example, creating a personal shopping profile, can utilize a portable computerized device such as a smart phone or tablet. The individual can choose personal shopping preferences by identifying ingredients in food, over-the-counter medicines, or other products that are either hazardous or undesirable to the individual consumer. Such can be based upon allergies, e.g. nuts, dairy, wheat, etc., dietary restrictions, e.g., vegetarian, diabetic, organic, etc., social concerns, e.g., free trade, local producers, etc., religious, or any other similar preferences. Additionally, the consumer could be alerted to other criteria, such as upcoming promotional deals, or if other members of their family have already purchased the product and what they thought of the experience. In one example, a customer might be on a budget, and the system might alert the customer if a meal is going over budget or propose alternatives that might improve the budget. The portable computerized device is used to scan products and identify their ingredients or other characteristics of the product such as calories, environmental considerations, or promotional deals by referencing the product in a centralized product database. The device can identify a product by scanning the bar code, a QR code, or other identifying marks on the product. When the customer scans a product that contains ingredients they have identified as undesirable in their user profile, the device alerts the customer. The device can monitor an indication from the individual, which can be individually or a combination of a hand gesture, voice command, or other means of input. Based upon the indication, the portable computerized device can reject the product and the customer replaces it on the shelf. Alternatively, the customer can add the product to the heir virtual shopping cart to purchase the product.

Hardware and software configurations of the systems disclosed herein can take many different embodiments. An augmented reality program can be installed upon a portable computerized device. In another embodiment, a portable computerized device can include an augmented reality program configured permanently to the hardware of the device. In one embodiment, a single personal shopping profile index server can be utilized remotely to provide personal shopping profiles in a plurality of stores, with communication of necessary information being transferred over a communications network. In another embodiment, a single remotely operated personal shopping profile index server can be used to provide personal shopping profiles for a single store. In one embodiment, a remote server can be used as a store personal shopping profiles index server, and a second, local, in-store server can be used to permit local wireless communication between customers and the local server. In another embodiment, a store personal shopping profile index server can be local to a store. Communication between portable computerized devices and a store parking space index server can be over a cellular network, over a local network operated by the store, or by other communications processes known in the art.

An expedited check out experience could be used by customers who have a personalized shopping profile. The expedited check out experience could include the use of a dedicated self-checkout station. For example, once a customer has completed their shopping, they could proceed to a dedicated check-out line. The customer could then select a payment process such as credit card or cash, pay for their purchases, and complete the transaction. In another embodiment, the customer could have a mobile payment option. For example, the portable computerized device could have an option to pay for the purchases, avoiding the need to get in a check-out line entirely.

A personal shopping profile for an individual can be stored within a server device for access by the individual or by others permitted to access the list by the individual. The personal shopping profile can be established by using very specific criteria to identify a product that may contain ingredients that are undesirable to the consumer or are otherwise unwanted. Ingredients can be identified by such criteria as a specific allergen such as gluten or nuts, vegetarian, vegan, or other, such as highly processed ingredients or high fructose corn syrup. For example, if the customer has gluten sensitivity, they could indicate this in their user profile. When a customer scans a product that contains gluten, an alert is displayed communicating this information to the customer. In another embodiment, if the customer has seasonal allergies, an application could monitor local weather forecasts and alert the customer when pollen counts are expected to be elevated. The software could then suggest products to address the customer's allergies, allowing the customer to choose a product.

In another example, if the customer has a child that is a vegan and scans a product that contains an ingredient that is from animal products, the consumer may wish to still purchase the product for other members of the family, but is now aware that the product is not fit for the vegan. This option allows the consumer to override potential warnings and purchase items that may otherwise be considered inappropriate. The consumer is, however, made aware of the presence of the ingredients. In another example, if a customer suffers from diabetes or has a family history of the disease, the portable computerized device could keep a running tally of the total amount of sugar the customer has scanned. This information could be stored in the customer's personalized shopping profile, giving the customer a detailed account of the amount of sugar purchased over long periods of time. This would give the customer an idea of how much sugar they have purchased in the previous weeks, months, and even years, allowing the customer to make more informed decisions about their shopping and dietary habits.

In another embodiment, the personal shopping profile could be preconfigured with a proprietary diet program. For example, when a customer scans a product, the calories, points, or other means for measuring diet and nutrition could be automatically counted and tallied. In another example, the proprietary diet program could indicate to the customer if a product has been scanned that contains ingredients that have been strictly forbidden in the diet, such as carbohydrates.

If a customer wishes to share preferences and user profiles, the personal shopping profile of the customer could be shared with specific members of the family or friends. For example, if a husband is shopping for his wife, she could share aspects of her personal shopping profile with him. In one embodiment, if the wife had a negative reaction to a moisturizing cream, that could be noted in her personal shopping profile. When the husband scans a product with similar ingredients, even if it is a different brand, the husband could be alerted to the wife's negative reaction and avoid buying a similar product that might have a similarly negative experience.

In another embodiment, the ecological or environmental concerns such as total embodied energy, total distance traveled, carbon footprint, recyclability, or reusability could be included. For customers who are concerned about the environmental impacts of their purchases, tracking this information for an individual shopping trip, and over the course of weeks, months, and years, could provide a more detailed picture of the environmental impacts of their purchases.

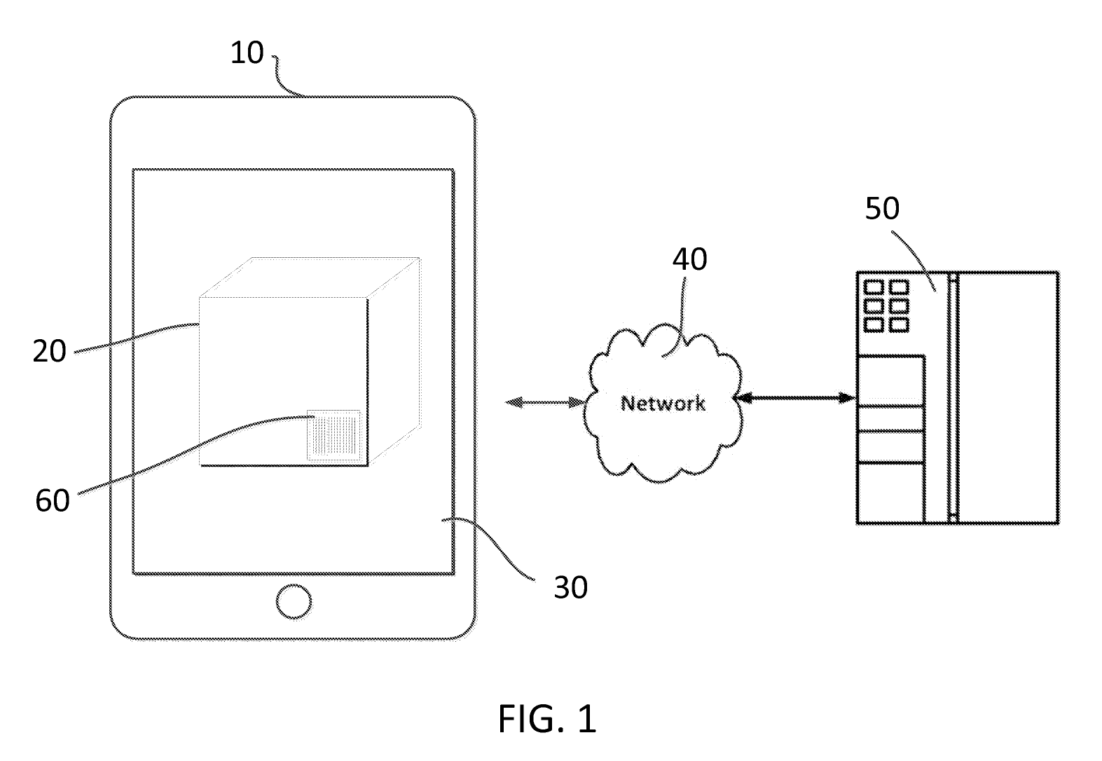

To illustrate, FIG. 1 is a schematic drawing illustrating an exemplary portable computerized device in communication with an exemplary store product index server, according to some embodiment of the disclosure. Portable computerized device 10 is illustrated, including view 30 through device 10. Included within view 30 is product 20 with UPC symbol 60. Device 10 is an exemplary portable computerized device including input devices configured to gather information and a processor configured to make determinations regarding data from the input devices. Store product index server 50 is illustrated including a remote computerized system with modules operating to share information gathered from device 10 with other possible servers in a network as discussed herein. Server 50 and device 10 are in communication through exemplary wireless communications network 40.

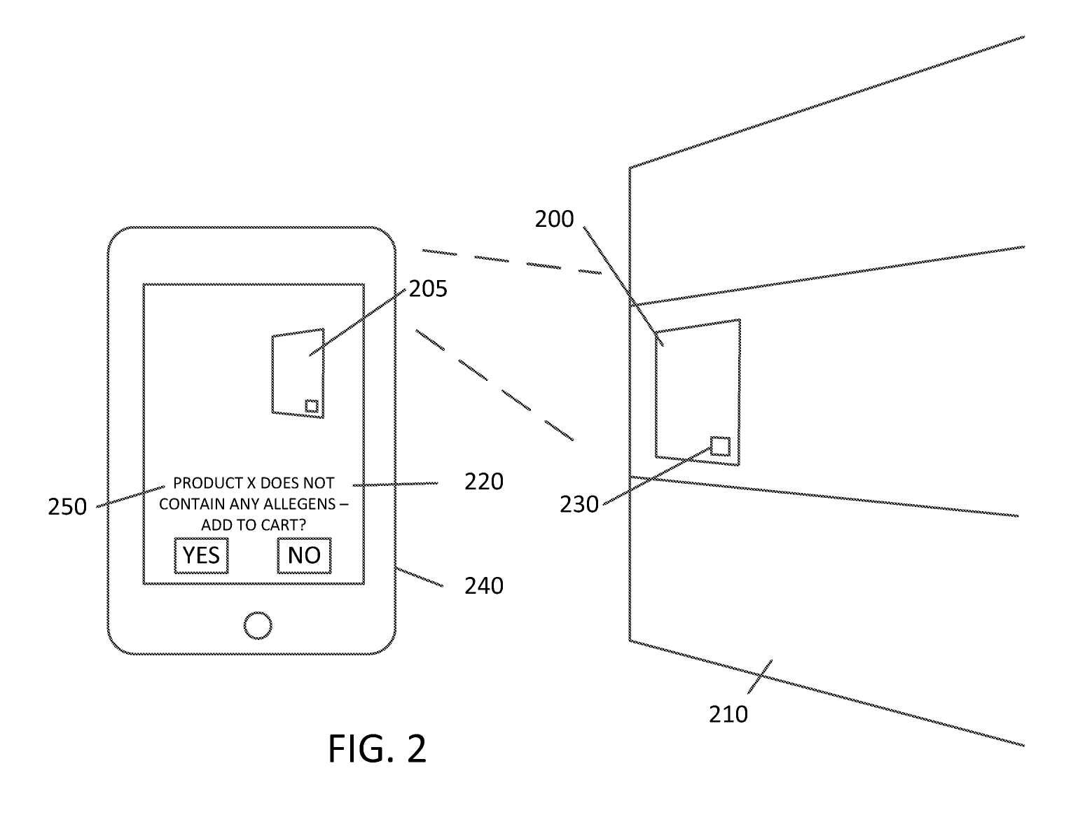

FIG. 2 is an exemplary view of a product being scanned by a portable computerized device illustrating that the product does not contain ingredients that the consumer has identified as unwanted, according to some embodiment of the discloser. Product 200 is scanned and identified by its UPC symbol 230 using a portable computerized device 240. The product does not contain ingredients that the consumer has identified as unwanted and is added to the virtual shopping cart, according to some embodiment of the disclosure. View 220 can illustrate objects visible on a video feed projected upon a portable computerized device 240, including image 205 of product 200. Further view 220 can include graphics projected upon the view of the individual using the device. A particular product can be selected according to processes disclosed herein, and an indicating graphic 250 can be projected on view 220, indicating whether or not the product contains ingredients specified in the personal shopping profile. Additionally, a message 250 can be projected upon view 220 prompting an action from the individual, for example, prompting an input to initiate adding the product to the customer's virtual shopping cart.

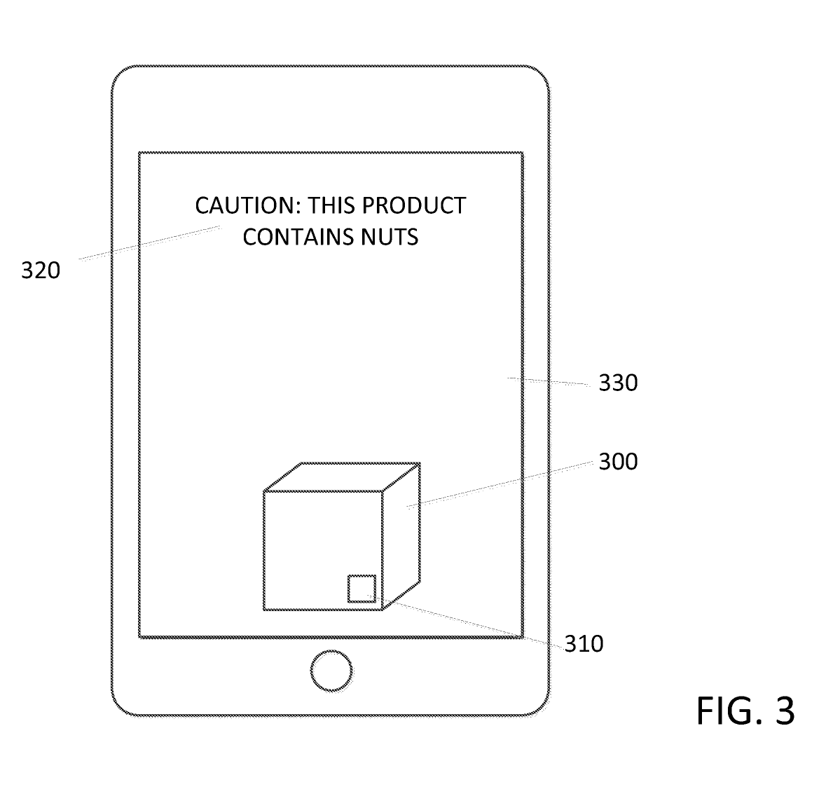

FIG. 3 is an exemplary view through a portable computerized device of a product and graphics projected upon the device illustrating warnings about the ingredients in the product, according to some embodiments of the disclosure. View 330 includes a product 300 located within a retail store. Through processes disclosed herein, the product can be identified within the store product index server using UPC symbol 310, and details regarding the product can be referenced from a remote database and displayed upon the device, such as alert 320.

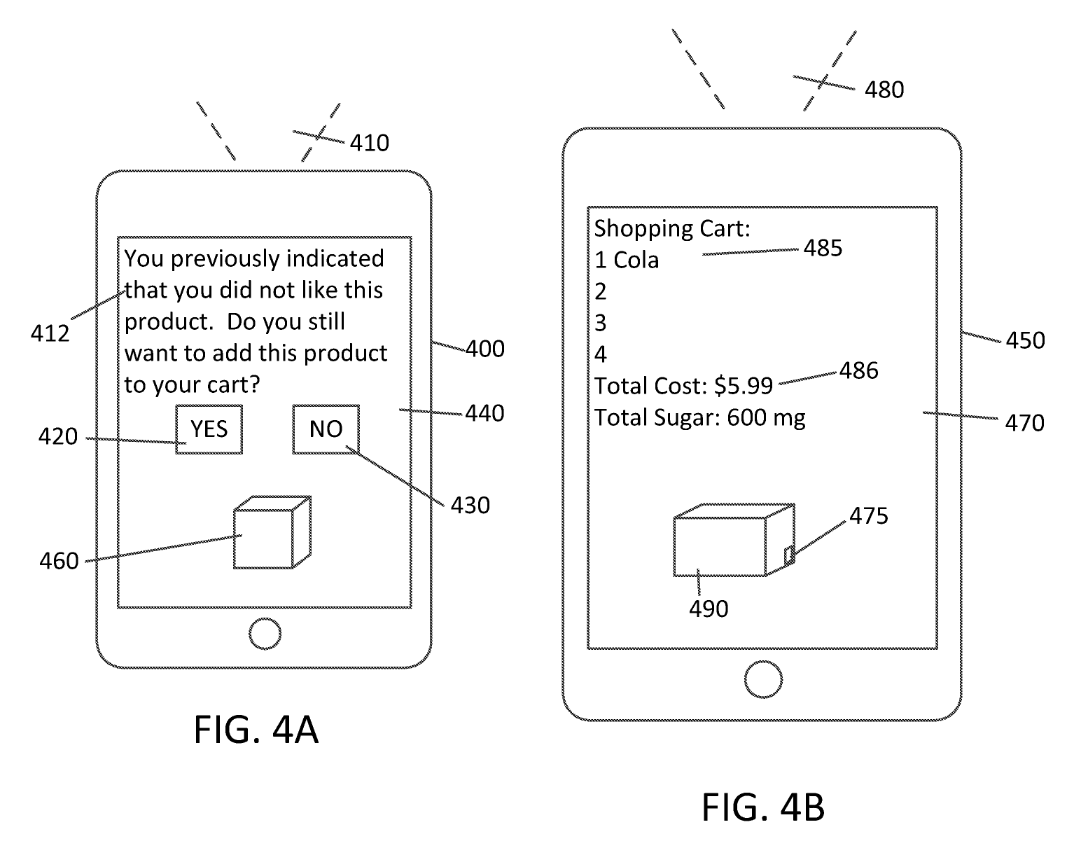

FIGS. 4A and 4B schematically illustrate exemplary portable computerized devices utilizing the processes disclosed herein. FIG. 4A is a schematic illustrating an exemplary portable computerized device embodied as a smart phone. Portable computerized device 400 includes a display 440. Display 440 includes message 412 prompting the viewer to confirm whether product 460 should be added to a virtual shopping cart, including inputs 420 and 430 permitting the user to confirm or reject, respectively, the viewed product for the virtual shopping cart. Device 400 additionally includes a camera device capturing view 410 in front of the device. FIG. 4B is a schematic illustrating an exemplary portable computerized device embodied as a tablet computer. Device 450 includes display 470 including a view 480 captured by a camera located on an opposite side of device 450 from display 470. A product 490 is included upon display 470. Product 490 is identified using QR code 475. Virtual shopping cart 485 lists products scanned and accepted for purchase by the customer. Running tallies of cost and other quantities are also listed 486.

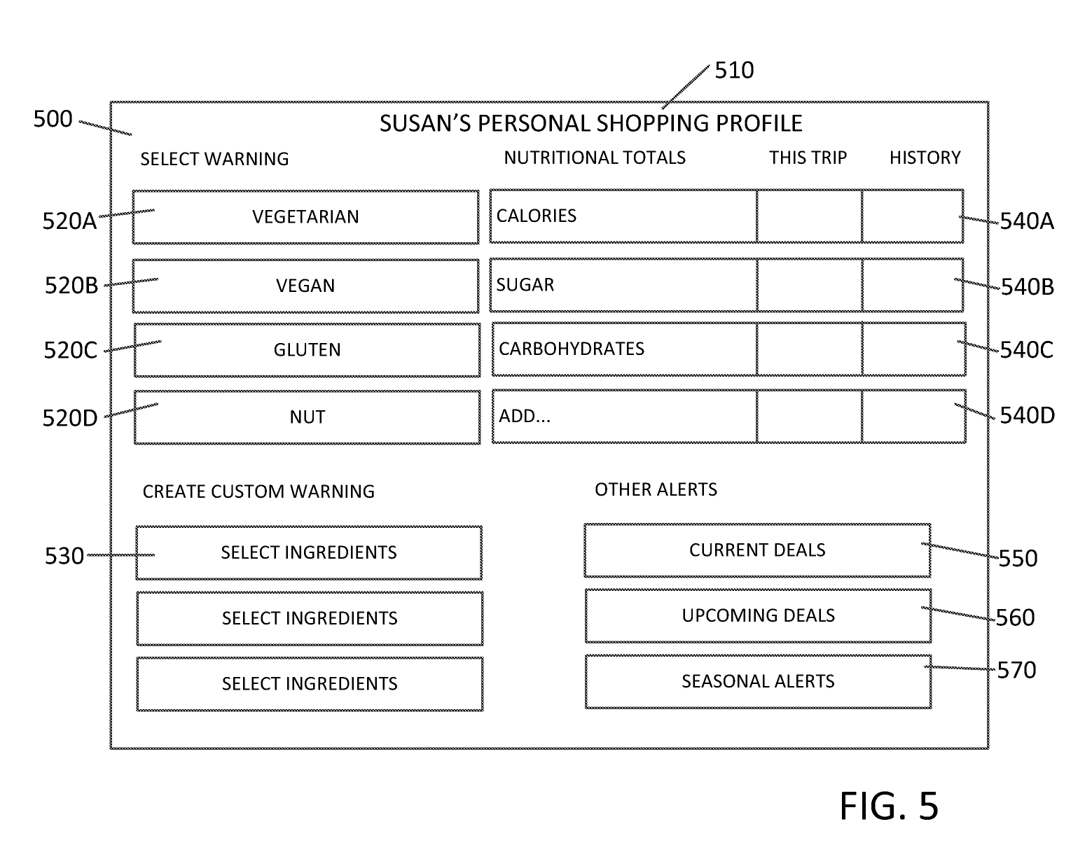

FIG. 5 is an exemplary computer display showing a customer profile and various options for the customer regarding ingredients in products, according to some embodiment of the disclosure. Display 500 includes a descriptive banner 510 identifying the displayed list. Display 500 further includes a list of options for ingredient alerts, including 520A, 520B, 520C, and 520D. Display 500 further includes shopping prompts 530 permitting action by allowing the customer to set customized alerts by searching for specific ingredients in products. Additionally, components 540A, 540B, 540C, and 540D list the total ingredients or other measurable characteristics of the products in the shopping cart, including for the current shopping trip and over longer time intervals. Additionally, inputs 550, 560, and 570 permit the viewer to initiate alerts informing them of current sales on similar products, upcoming sales on similar products, and seasonal alerts. For example, if a customer indicates in their personal shopping profile that they suffer from seasonal allergies, that person could be alerted when the pollen count in the area is expected to be unusually high, allowing them to purchase products to address this. A number of additional or alternative display options for display 500 are envisioned, and the disclosure is not intended to be limited to the particular examples provided herein.

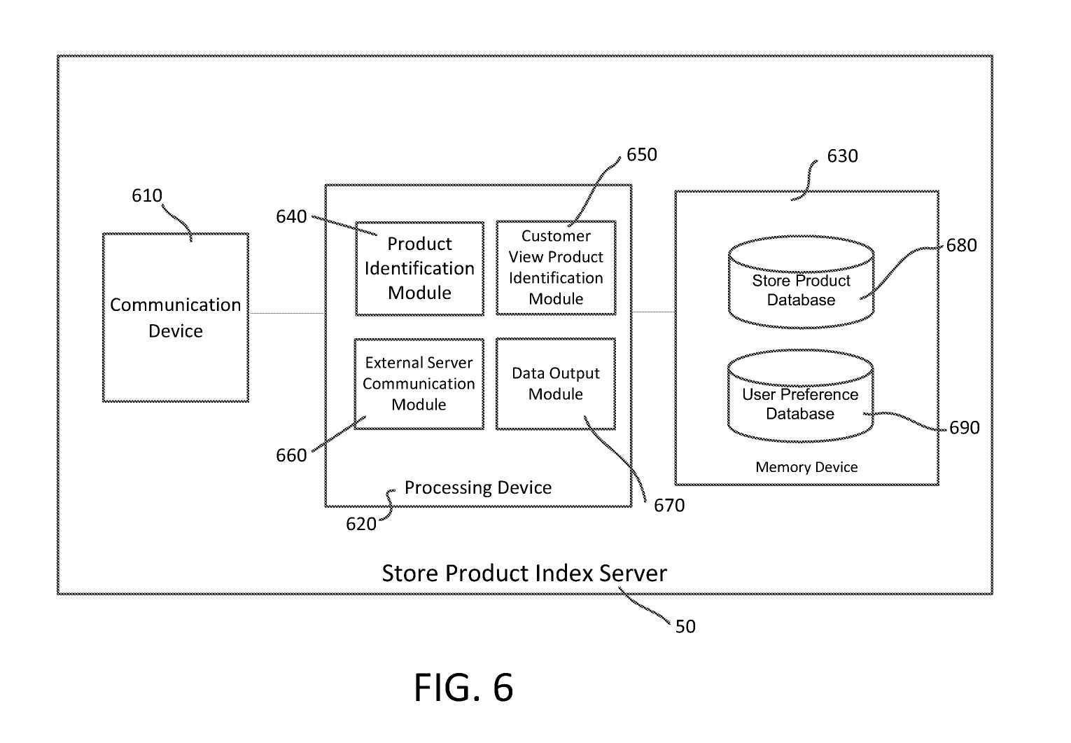

FIG. 6 is a schematic illustrating an exemplary store product index server, according to some embodiment of the disclosure. In the illustrated embodiment, the store product index server 600 may include a processing device 620, a communication device 610, and memory device 630.

The processing device 620 can include memory, e.g., read only memory (ROM) and random access memory (RAM), storing processor-executable instructions and one or more processors that execute the processor-executable instructions. In embodiments where the processing device 620 includes two or more processors, the processors can operate in a parallel or distributed manner. In the illustrative embodiment, the processing device 620 executes one or more of a product identification module 640, a customer view product identification module 650, an external server communication module 660, and a data output module 670.

The communication device 610 is a device that allows the store product index server 600 to communicate with another device, e.g., a portable computerized device through a wireless communication network connection. The communication device 610 can include one or more wireless transceivers for performing wireless communication and/or one or more communication ports for performing wired communication.

The memory device 630 is a device that stores data generated or received by the store product index server 600. The memory device 630 can include, but is not limited to a hard disc drive, an optical disc drive, and/or a flash memory drive. Further, the memory device 630 may be distributed and located at multiple locations. The memory device 630 is accessible to the processing device 620. In some embodiments, the memory device 630 includes a store product database 680 and a user preference database 690.

In some embodiments, the store product database 680 stores information about a product, including ingredients of the product, calories, carbohydrates, and other information regarding the product. The store product database 680 may further store other information about a particular product, including price, weight, availability, and similarity of the product to other available products.

The product identification module 640 can monitor a product that has been scanned and reference the store product database 680 to determine, based upon a scanned image like a UPC symbol, if the product contains ingredients the customer has indicated as unwanted. Data output module 670 can manage information related to the identified product such as ingredient information and can manage a pending shopping cart for output to a portable computerized device. External server communication module 660 can communicate with external servers to determine additional criteria, such as referencing published dietary or nutritional information.

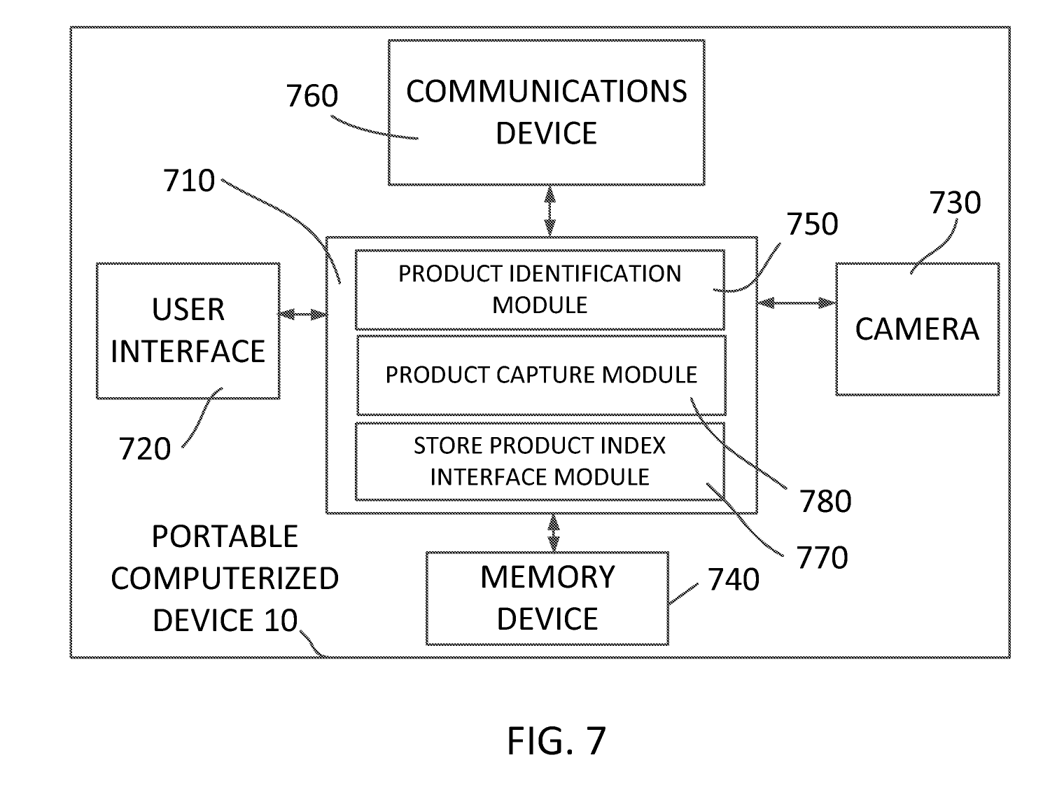

FIG. 7 is a schematic illustrating an exemplary portable computerized device configured to implement processes disclosed herein, according to some embodiment of the discloser. Device 700 includes a processing device 710, a user interface 720, a communication device 760, a camera 730, and a memory device 740.

The processing device 710 can include memory, e.g., read only memory (ROM) and random access memory (RAM), storing processor-executable memory (ROM) and random access memory (RAM), storing processor-executable instructions and one or more processors that execute the processor-executable instructions. In embodiments where the processing device 710 includes two or more processors, the processors can operate in a parallel or distributed manner. In the illustrative embodiment, the processing device 710 can execute the operating system of the portable computerized device. In the illustrative embodiment, the processing device 710 also executes a product identification module 750, a store product index server interface module 770, and a product capture module 780, which are described in greater detail below.

The user interface 720 is a device that allows a user to interact with the portable computerized device. While one user interface 720 is shown, the term “user interface” can include, but is not limited to, a touch screen, a physical keyboard, a mouse, a microphone, and/or a speaker. The communication device 760 is a device that allows the portable computerized device to communicate with another device, e.g., a store product index server. The communication device 760 can include one or more wireless transceivers for performing wireless communication and/or one or more communication ports for performing wired communication. The memory device 740 is a device that stores data generated or received by the portable computerized device. The memory device 740 can include, but is not limited to, a hard disc drive, an optical disc drive, and/or a flash memory drive.

The camera 730 is a digital camera that captures a digital photograph. The camera 730 receives an instruction to capture an image and captures an image of a view proximate to the camera. The digital photograph can be a bitmap file. The bitmap file can be a bitmap, a JPEG, a GIF, or any other suitably formatted file. The camera 730 can receive the instruction to capture the image from the processing device 710 and can output the digital photograph to the processing device 710.

Product capture module 780 monitors images captured by camera 730 and/or other inputs that can be used to indicate to a product. Product capture module 780, upon monitoring an indication to a product, uses image recognition, barcode recognition, or other processes to index the product. Information gathered by product capture module can be communicated to the product store index server to particularly identify the product according to the processes disclosed herein.

Product identification module 750 interfaces with store product index server. Product identification module 750 further collects information through the user interface 720 regarding the product, such as the customer's preferences regarding the product, and communicates the collected information to the social media application. Different embodiments of the disclosure can include product identification module 750 and a data output module of a store product index server implementing different portions of the tasks required to collect the product information as disclosed herein.

Embodiments in accordance with the present disclosure may be embodied as an device, process, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

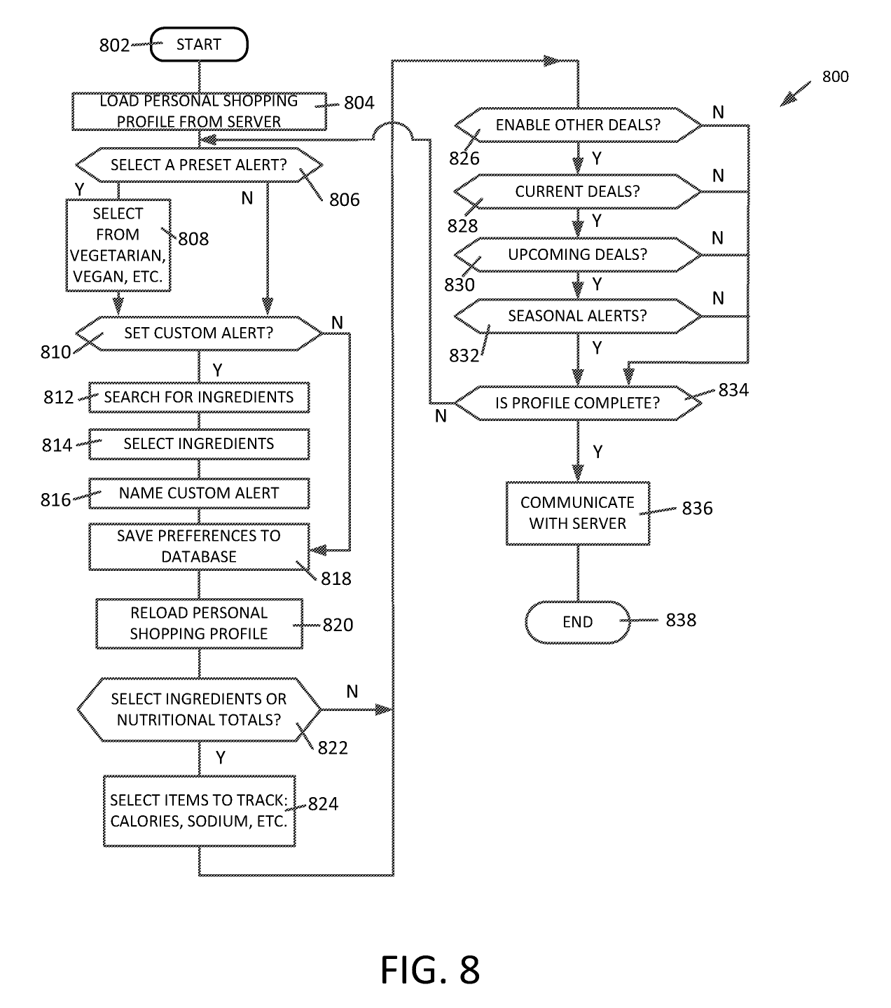

FIG. 8 is a flowchart illustrating an exemplary process to create a list of ingredients that the consumer does not wish to purchase or other similar alerts, according to some embodiment of the disclosure. Process 800 operates within a portable computerized device and begins at step 802. At step 804, the process loads the personal shopping profile from the server. At step 806, the user of the device is prompted to select a preset alert for ingredients. If the user opts to select a preset alert, process 800 advances to step 808 whereat the user can select an alert. If the user declines to accept a preset alert, process 800 advances to step 810. At step 810, the user is prompted to enter a custom alert. At step 812, the user is prompted to enter a search term or phrase to find ingredients deemed unacceptable by the user. At step 814, the user selects ingredients that were returned from the search query. At step 816, the user is prompted to create a name for the custom alert. At step 818, the preferences are related to the server. At step 820, the personal shopping profile is referenced from the server. At step 822 the user is prompted to select other product criteria to monitor. If the user opts to select other product criteria to monitor, the user continues on to step 824 to select another criteria to track. If the user declines to select additional criteria, the process 800 continues to step 826. At step 826, the user is prompted to enable other deals. If the user opts to accept other deals, process 800 continues to step 828, 830, and 832 where the user can opt to enable current deals, upcoming deals, and/or seasonal deals, respectively. If the user declines to accept other deals, process 800 continues on to step 834. At step 834, a determination is made whether the personal shopping profile is complete. If the personal shopping profile is not complete, the process returns to step 806. If the personal shopping profile is complete, the process advances to step 836 whereat the personal shopping profile is communicated to a server. At step 838, the process ends. The process illustrated is a non-limiting example. A number of exemplary processes are envisioned, including a process wherein the personal shopping profile is updated in real-time to the server, is envisioned. The disclosure is not intended to be limited to the exemplary process provided.

The flowchart and block diagrams in the flow diagrams illustrate the architecture, functionality, and operation of possible implementations of systems, processes, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing device to function in a particular manner, such that the instructions stored in the computer-readable medium produce an article of manufacture including instruction means which implement the function/act specified in the flowchart and/or block diagram block or blocks.

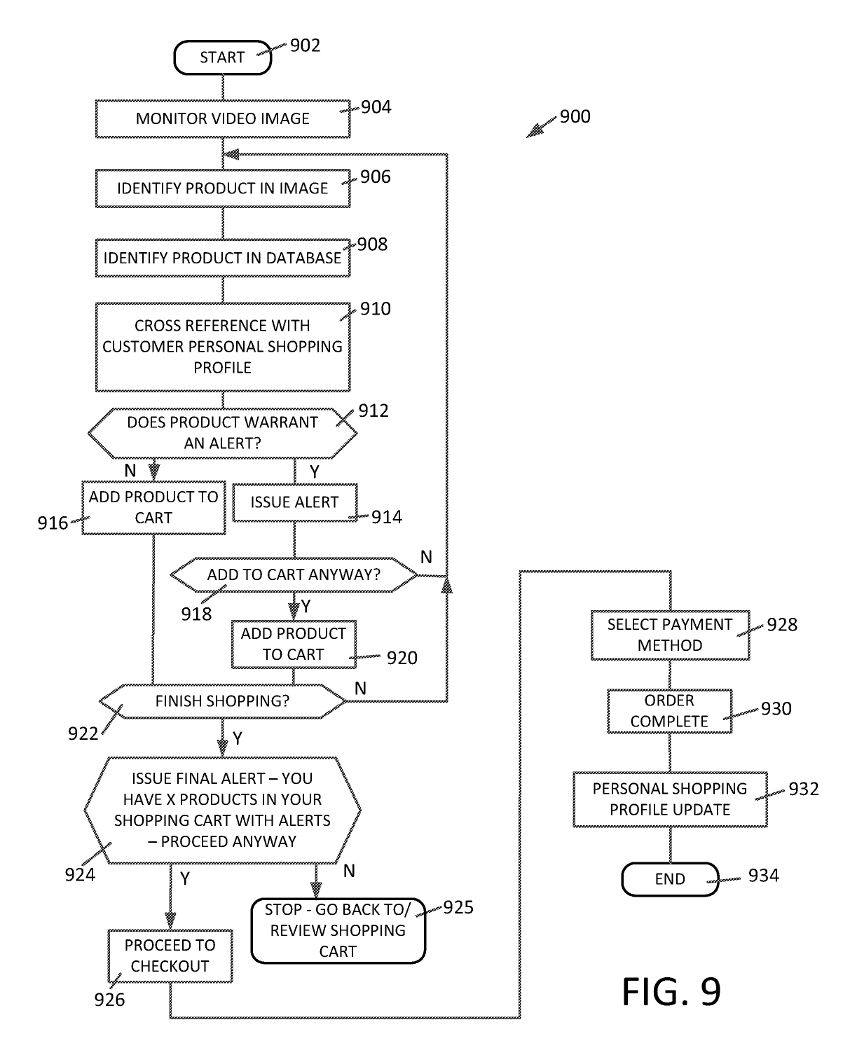

FIG. 9 is a flowchart illustrating an exemplary process to scan, select, and purchase items in a store. Process 900 operates within a portable computerized device and begins at step 902. At step 904, a video image captured by a camera of the device is monitored. At step 906, the video image is analyzed, and an identifying mark such as a QR code or UPC symbol is identified. At step 908, a store product database is referenced, and the product is identified within the database. At step 910, the identified product is cross referenced with the customer's personal shopping profile. At step 912, if the product is identified as being within the shopper's personal profile, process 900 continues on to step 914 and issues an alert to the customer. If an alert is issued, process 900 continues on to step 918, prompting the customer to decide whether or not to override the alert and add the product to the shopping cart anyway in step 920. If the product does not match the criteria set by the customer as described in steps 910 through 912, process 900 continues on to step 916 where the product is added to the virtual shopping cart. At step 922, a determination is made whether the customer has finished shopping. If the customer has not finished shopping, the process returns to step 904. If the customer has finished shopping, the process advances to step 924 whereat a final alert is issued. The customer is then prompted to either go back to the shopping cart and review the products causing the alerts at step 925, or ignore the final alert and proceed to step 926, the checkout. Step 925 can end the process, with the customer, for example, asking store personnel for assistance, or flagged items can be removed and the process can reinitiate at step 906. The checkout could be a mobile payment available on the portable computerized device. In another embodiment, the customer proceeds to a self-checkout line in the store. In step 928, the customer is prompted to select a payment process. At step 930, the order is formally completed. At step 932, the personal shopping profile is updated. At step 934 the process ends. The process illustrated is a non-limiting example. A number of exemplary processes are envisioned. The disclosure is not intended to be limited to the exemplary process provided.

The above description of illustrated examples of the present disclosure, including what is described in the Abstract, are not intended to be exhaustive or to be limitation to the precise forms disclosed. While specific embodiments of, and examples for, the disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

What is claimed is:

1. A computer-implemented process to provide a customer with information about an item to be purchased, the process comprising:
within a processor of a portable computerized device, monitoring a scan of the item to be purchased;
automatically referencing a remote database to reference a list of ingredients in the item to be purchased;
within the processor, cross-referencing the list of ingredients to a shopping profile of the customer; and
displaying an alert to the customer upon a display of the portable computerized device based upon the cross-referencing.

2. The computer-implemented process of claim 1, wherein cross-referencing the list of ingredients to the shopping profile comprises comparing the list of ingredients to an allergy of the customer.

3. The computer-implemented process of claim 2, wherein comparing the list of ingredients to the allergy of the customer comprises comparing the list to one of a nut allergy, a dairy allergy, and a gluten allergy.

4. The computer-implemented process of claim 1, wherein cross-referencing the list of ingredients to the shopping profile comprises comparing the list of ingredients to a dietary restriction of the customer.

5. The computer-implemented process of claim 1, wherein cross-referencing the list of ingredients to the shopping profile comprises comparing the list of ingredients to a restriction based upon social concerns of the customer.

6. The computer-implemented process of claim 1, wherein cross-referencing the list of ingredients to the shopping profile comprises comparing the list of ingredients to a restriction based upon religious concerns of the customer.

7. The computer-implemented process of claim 1, wherein cross-referencing the list of ingredients to the shopping profile comprises comparing the list of ingredients to a restriction based upon budgetary concerns of the customer.

8. The computer-implemented process of claim 1, wherein cross-referencing the list of ingredients to the shopping profile comprises comparing the list of ingredients to a restriction based upon nutritional totals required by the customer.

9. The computer-implemented process of claim 8, wherein comparing the list of ingredients to a restriction based upon nutritional totals required by the customer comprises determining a total number of calories in a product.

10. The computer-implemented process of claim 8, wherein comparing the list of ingredients to a restriction based upon nutritional totals required by the customer comprises determining a total quantity of sugar in a product.

11. The computer-implemented process of claim 8, wherein comparing the list of ingredients to a restriction based upon nutritional totals required by the customer comprises determining a total quantity of carbohydrates in a product.

12. The computer-implemented process of claim 8, wherein comparing the list of ingredients to a restriction based upon nutritional totals required by the customer comprises determining a total quantity of sodium in a product.

13. The computer-implemented process of claim 1, further comprising providing to the customer a process upon the portable computerized device to edit the shopper profile.

14. The computer-implemented process of claim 1, further comprising providing to the customer upon the display an option to reject the item based upon the alert.

15. A computerized server comprising:
a user preference database comprising stored information about a customer including an allergy of the customer;
a product identification module including programming to identify a particular product based upon a scan by the customer of an item to be purchased;
a store product database comprising information about the particular product including a list of ingredients within the product; and
a data output module providing to a portable computerized device of the customer the information about the customer including the allergy and the information about the particular product including the list of ingredients.

16. A software application including programming to provide a customer with information about an item to be purchased, the application comprising:
within a processor of a portable computerized device, programming to:
monitor a scan of the item to be purchased;
automatically reference a remote database to reference a list of ingredients in the item to be purchased;
cross-reference the list of ingredients to a shopping profile of the customer; and
display an alert to the customer upon a display of the portable computerized device based upon the cross-referencing.

17. The software application of claim 16, wherein the programming to cross-reference the list of ingredients to the shopping profile comprises programming to compare the list of ingredients to an allergy of the customer.

18. The software application of claim 16, wherein the programming to cross-reference the list of ingredients to the shopping profile comprises programming to compare the list of ingredients to a dietary restriction of the customer.
